(19) United States
(12) Patent Application Publication
(10) Pub. No.: US 2017/0187835 A1
(43) Pub. Date: Jun. 29, 2017

(54) Technologies for unified and modular gateway abstraction

(71) Applicants: Lee Booi Lim, Batu Maung (MY); Mousumi M. Hazra, Beaverton, OR (US); Usman Sarwar, Penang (MY)

(72) Inventors: Lee Booi Lim, Batu Maung (MY); Mousumi M. Hazra, Beaverton, OR (US); Usman Sarwar, Penang (MY)

(21) Appl. No.: 14/998,266

(22) Filed: Dec. 26, 2015

(51) Int. Cl. H04L 29/08; H04L 29/06; H04L 12/26

(52) U.S. Cl. CPC H04L 67/34; H04L 43/0876; H04L 69/03

(57) ABSTRACT

Technologies for enabling functionality of a gateway device are described. A gateway device installs, at run time, a first plugin associated with a first communication protocol and a first application. The first plugin includes computer-executable instructions that enable the gateway device to communicate with a client computing device that executes the first application using the first communication protocol. Additionally, the gateway device receives a command from the client computing device using the first communication protocol to provide requested data pertaining to at least one field device coupled to the gateway device. Additionally, the gateway device transmits the requested data to the client computing device using the first communication protocol, in response to the command. Other embodiments are described and claimed.

### BACKGROUND

In typical systems that include field devices, such as sensor devices and actuator devices, coupled to a gateway device, the communication protocols and interfaces supported by the gateway device are limited to a predefined set that generally is not changed once the gateway device is put into operation. Accordingly, any new field devices that are to be coupled to the gateway device must use the predefined communication protocols in order to communicate with the gateway device. Similarly, developers of software that interacts with the gateway device, such as from a remote computing device, must develop the software in accordance with one of the predefined interfaces supported by the gateway device. Such aspects of conventional gateway devices limit their ability to interoperate with new devices that are configured to communicate using protocols and/or interfaces that the conventional gateway devices were not preconfigured to support, prior to being put into operation.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for gateway abstraction;

FIG. 2 is a simplified block diagram of at least one embodiment of an environment of the gateway device of FIG. 1;

FIG. 3 is a simplified flow diagram of at least one embodiment of a method for managing plugins that may be executed by the gateway device of FIGS. 1 and 2;

FIG. 4 is a simplified flow diagram of an example process for receiving communications using an installed plugin that may be performed by the gateway device of FIGS. 1 and 2;

FIG. 5 is a simplified flow diagram of an example process for transmitting communications using an installed plugin that may be performed by the gateway device of FIGS. 1 and 2;

FIG. 6 is a simplified block diagram of example components of an application and protocol plugin database included in the gateway device of FIGS. 1 and 2;

FIG. 7 is a simplified block diagram of example components of an operational database included in the gateway device of FIGS. 1 and 2; and

FIG. 8 is a simplified block diagram of example components of a device plugin database included in the gateway device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

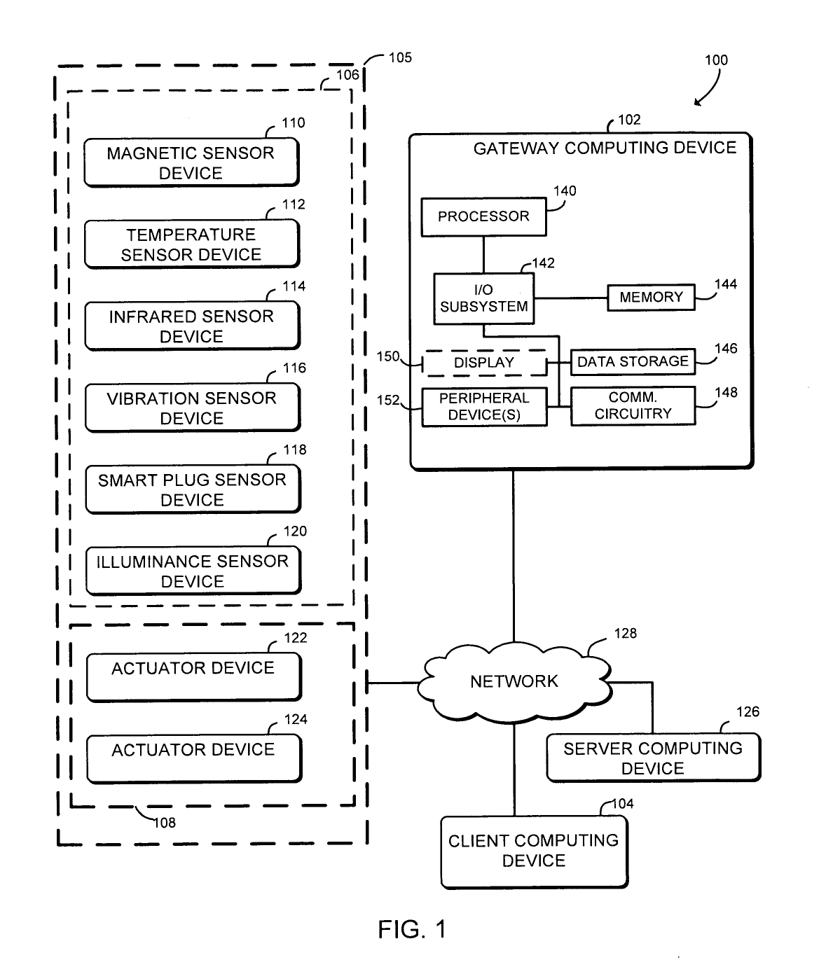

Referring now to FIG. 1, in an illustrative embodiment, a system 100 for gateway abstraction includes a gateway computing device 102, one or more field devices 105, a client computing device 104, and a server computing device 126. In use, the gateway computing device 102 is configured to receive and install plugins that enable the gateway computing device 102 to communicate with the field devices 105 and applications executing on remote computing devices (e.g., client computing device 104 and/or server computing device 126) that the gateway computing device 102 was previous unable to communicate with. To do so, the gateway computing device 102 installs and uses the plugins at run time. As such, the gateway computing device 102 does not cease operations in order to install and use new plugins. The plugins may be embodied as, or otherwise include, computer-executable instructions that implement specific communication protocols and/or interfaces, thereby abstracting away the details of the communication protocols and interfaces from other functions performed by the gateway computing device 102. Accordingly, the plugins enable the development of products that focus on new data collection and data processing functionality, without regard to the specifics of the underlying communication protocols, to report data to the cloud (e.g., server computing device 126) for further processing and logging without the need to handle cloud communication protocols, and to handle hardware and software disparities in connecting to and managing field devices 105 connected to the gateway computing device 102.

The gateway computing device 102 may be embodied as any type of server or computing device capable of communicating with field devices 105, client computing device 104 and server computing device 126, adding functionality to support new communication protocols and/or interfaces using plugins, and performing other functions described herein. For example, the gateway computing device 102 may be embodied as, without limitation, a server computer, a computer, a computing device, a workstation, distributed computing system, a multiprocessor system, a consumer electronic device, a smart appliance, a laptop computer, a notebook computer, a tablet computer, a smartphone, a mobile computing device, and/or any other computing device capable of performing the functions described herein. As shown in FIG. 1, the illustrative gateway computing device 102 includes a processor 140, an I/O subsystem 142, a memory 144, a data storage device 146, a display 150, and peripheral devices 152. Of course, the gateway computing device 102 may include other or additional components, such as those commonly found in a workstation (e.g., various input/output devices), in other embodiments. Further, in some embodiments, the gateway computing device 102 does not include the display 150. Additionally, in some embodiments, one or more of the illustrative components may be incorporated in, or otherwise form a portion of, another component. For example, the memory 144, or portions thereof, may be incorporated in the processor 140 in some embodiments.

The processor 140 may be embodied as any type of processor capable of performing the functions described herein. For example, the processor may be embodied as a single or multi-core processor(s), digital signal processor, microcontroller, or other processor or processing/controlling circuit. Similarly, the memory 144 may be embodied as any type of volatile or non-volatile memory or data storage capable of performing the functions described herein. In operation, the memory 144 may store various data and software used during operation of the gateway computing device 102 such as operating systems, applications, programs, libraries, and drivers. The memory 144 is communicatively coupled to the processor 140 via the I/O subsystem 142, which may be embodied as circuitry and/or components to facilitate input/output operations with the processor 140, the memory 144, and other components of the gateway computing device 102. For example, the I/O subsystem 142 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 142 may form a portion of a system-on-a-chip (SoC) and be incorporated, along with the processor 140, the memory 144, and other components of the gateway computing device 102, on a single integrated circuit chip.

The data storage device 146 may be embodied as any type of device or devices configured for short-term or long-term storage of data such as, for example, memory devices and circuits, memory cards, hard disk drives, solid-state drives, or other data storage devices. The data storage device 146 may store, for example, validation instructions, test results, profiles, and reports.

The gateway computing device 102 may also include a communication subsystem 148, which may be embodied as any communication circuit, device, or collection thereof, capable of enabling communications between the gateway computing device 102 and other remote devices over a computer network (not shown). The communication subsystem 128 may be configured to use any one or more communication technology (e.g., wired or wireless communications) and associated protocols (e.g., MQTT, Modbus, ZigBee, Ethernet, Bluetooth®, Wi-Fi®, WiMAX, etc.) to effect such communication.

Additionally, the gateway computing device 102 may include a display 150 that may be embodied as any type of display capable of displaying digital information such as a liquid crystal display (LCD), a light emitting diode (LED), a plasma display, a cathode ray tube (CRT), or other type of display device. In some embodiments, the gateway computing device 102 may also include one or more peripheral devices 152. The peripheral devices 152 may include any number of additional input/output devices, interface devices, and/or other peripheral devices. It should be appreciated that the gateway computing device 102 may be embodied as multiple devices cooperating together to facilitate the functionality described below.

The field devices 105 may be embodied as any type of input or output device such as sensors, actuators, motors, and/or the like. The illustrative field devices 105 include one or more sensor devices 106 and/or one or more actuator devices 108. The sensor devices 106 may be embodied as, or otherwise include, any type of sensors. Illustratively, the sensor devices 106 include a magnetic sensor device 110, a temperature sensor device 112, an infrared sensor device 114, a vibration sensor device 116, a smart plug sensor device 118, and an illuminance sensor device 120. Of source, the sensor devices 108 may include additional or other sensor devices in other embodiments. The illustrative magnetic sensor device 110 is configured to transmit data to gateway computing device 102 pertaining to magnetic fields detected by the magnetic sensor device 110. The illustrative temperature sensor device 112 is configured to transmit data to the gateway computing device 102 pertaining to temperatures detected by the temperature sensor device 112. The illustrative infrared sensor device 114 is configured to transmit data to the gateway computing device 102 indicating infrared radiation detected by the infrared sensor device 114. The illustrative vibration sensor device 116 is configured to transmit data to the gateway computing device 102 pertaining to vibrations detected by the vibration sensor device 116. The illustrative smart plug sensor device 118 is configured to transmit data to the gateway computing device 102 representing energy usage of devices coupled to the smart plug sensor device 118. The illustrative illuminance sensor device 120 is configured to transmit data to the gateway computing device 102 indicating, for example, intensities and durations of light detected by the illuminance sensor device 120.

The actuator devices 108 may be embodied as, or otherwise include, any type of actuator device. Illustratively, the actuator device 122 include an electromechanical transducer that selectively opens and closes a switch in response to receiving corresponding commands from the gateway computing device 102. The actuator device 124 may be similarly configured. In some embodiments, one or more of sensor devices 106 and actuator devices 108 are incorporated into the same device, for example a smart plug.

The client computing device 104 may be embodied as any type compute device capable of performing the functions described herein, including, without limitation, a computer, a computing device, a workstation, distributed computing system, a multiprocessor system, a server computer, a consumer electronic device, a smart appliance, a laptop computer, a notebook computer, a tablet computer, a smartphone, a mobile computing device, and/or any other computing device capable of performing the functions described herein. As such, the client computing device 104 may include components commonly found in a compute device such as a processor, an I/O subsystem, a memory, a data storage device, communication circuitry, and one or more peripheral devices. Such components may be substantially similar to those like components of the gateway computing device 102 described above. As such, further descriptions of the like components are not repeated herein with the understanding that the description of the corresponding components provided above in regard to the gateway computing device 102 applies equally to the corresponding components of the destination computing device 106. Although shown separately in FIG. 1, in some embodiments, the client computing device 104 and the server computing device 126 may be included in the same computing device.

The server computing device 126 may be embodied as any type compute device capable of performing the functions described herein, including, without limitation, a server computer, a computer, a computing device, a workstation, distributed computing system, a multiprocessor system, a consumer electronic device, a smart appliance, a laptop computer, a notebook computer, a tablet computer, a smartphone, a mobile computing device, and/or any other computing device capable of performing the functions described herein. As such, the server computing device 126 may include components commonly found in a compute device such as a processor, an I/O subsystem, a memory, a data storage device, communication circuitry, and one or more peripheral devices. Such components may be substantially similar to those like components of the gateway computing device 102 described above. As such, further descriptions of the like components are not repeated herein with the understanding that the description of the corresponding components provided above in regard to the gateway computing device 102 applies equally to the corresponding components of the destination computing device 106.

The gateway computing device 102 is configured to communicate with the field devices 105, the client computing device 104, and the server computing device 126 over a network 128 (the “cloud”). The network 128 may be embodied as any number of various wired and/or wireless networks. For example, the network 128 may be embodied as, or otherwise include, a wired or wireless local area network (LAN), a wired or wireless wide area network (WAN), a cellular network, and/or a publicly-accessible, global network such as the Internet. As such, the network 128 may include any number of additional devices, such as additional computers, routers, and switches, to facilitate communications among the devices of the system 100.

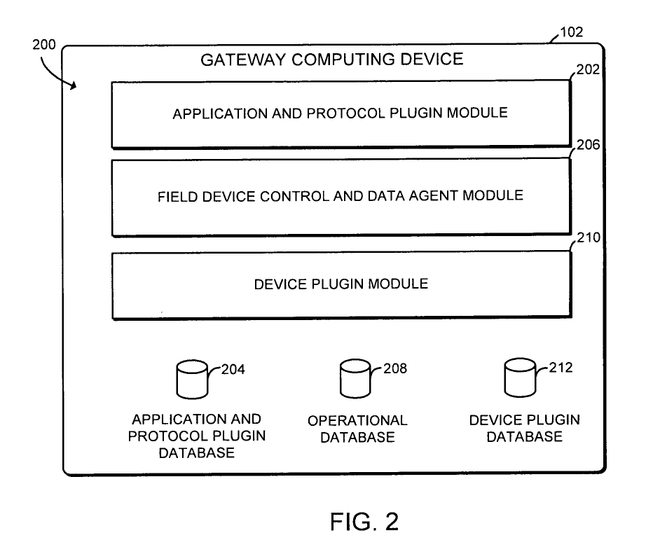

Referring now to FIG. 2, in the illustrative embodiment, the gateway computing device 102 establishes an environment 200 during operation. The illustrative embodiment 200 includes an application and protocol plugin module 202, a field device control and data agent module 206, and a device plugin module 210. The application and protocol plugin module 202, the field device control and data agent module 206, and the device plugin module 210 form a unified and modular abstraction framework. The various modules of the environment 200 may be embodied as hardware, firmware, software, or a combination thereof. As such, in some embodiments, one or more of the modules of the environment may be embodied as circuitry or a collection of electrical devices (e.g., an application and protocol plugin circuit 202, a field device control and data agent circuit 206, and a device plugin circuit 210, etc.). It should be appreciated that, in such embodiments, one or more of the application and protocol plugin module 202, the field device control and data agent module 206, and the device plugin module 210 may form a portion of one or more of the processor 140, the I/O subsystem 142, and/or other components of the gateway computing device 102. Additionally, in some embodiments, one or more of the illustrative modules may form a portion of another module and/or one or more of the illustrative modules may be independent of one another. Further, in some embodiments, one or more of the modules of the environment 200 may be embodied as virtualized hardware components or emulated architecture, which may be established and maintained by the processor 140 or other components of the gateway computing device 102.

The application and protocol plugin module 202, which may be embodied as hardware, firmware, software, virtualized hardware, emulated architecture, and/or a combination thereof as discussed above, is configured to maintain an application and protocol plugin database 204 as shown in FIG. 2. The application and protocol plugin module 202 is configured to install, at run time, one or more plugins that enable the gateway computing device 102 to communicate with other devices using a communication protocol or interface that the gateway computing device 102 previously did not support. For example, by installing a first plugin at run time, the application and protocol plugin module 202 may enable the gateway computing device 102 to receive data from and transmit data to an application executing on the client computing device 104. By installing the plugin at run time, rather than requiring the gateway computing device 102 to shut down and restart, the gateway computing device 102 is able to add new communication functionality to the gateway computing device 102 without interrupting communications with other devices and applications.

The field device control and data agent module 206, which may be embodied as hardware, firmware, software, virtualized hardware, emulated architecture, and/or a combination thereof as discussed above, is configured to manage an operational database 208 and is configured to perform functions that are independent of specific communication protocols and interfaces, and to interact with the application and protocol plugin module 202 and the device plugin module 210, for example through one or more application programming interfaces (“APIs”). More specifically, the field device control and data agent module 206 is configured to perform functions to process data received from and transmitted to other devices, such as field devices 105, client computing device 104, and/or server computing device 126, while relying on the application and protocol plugin module 202 and the device plugin module 210 to translate and format the data pursuant to requirements of the particular devices that the gateway computing device 102 is in communication with. The device plugin module 210 may be embodied as hardware, firmware, software, virtualized hardware, emulated architecture, and/or a combination thereof as discussed above.

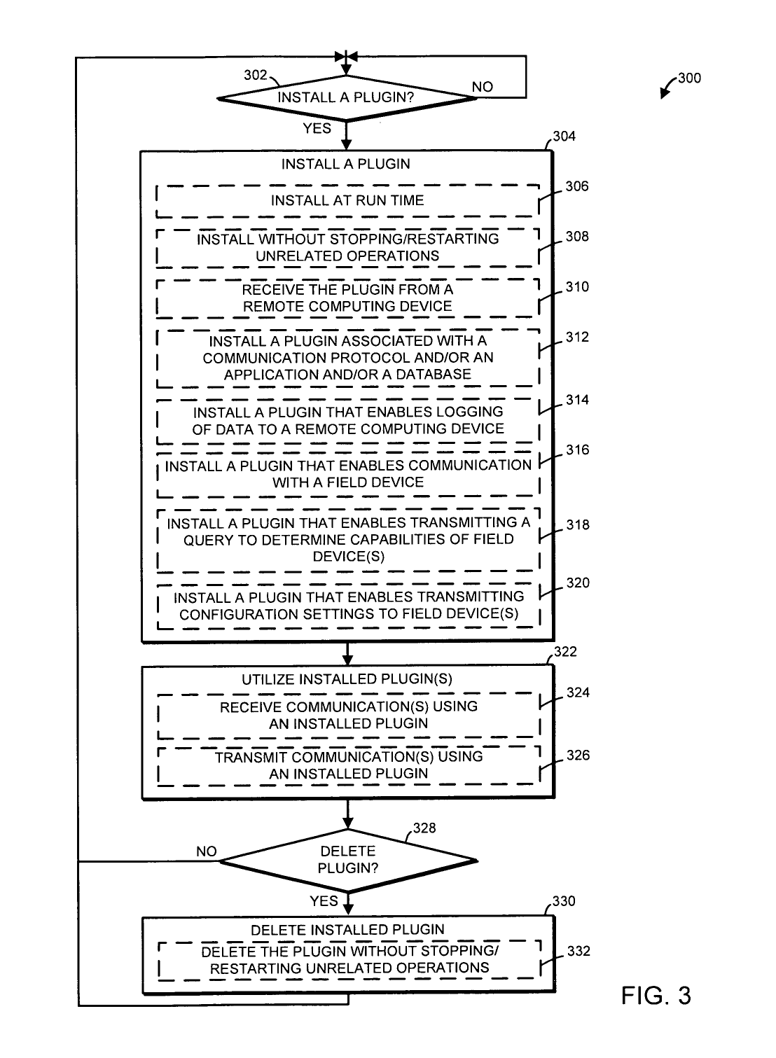

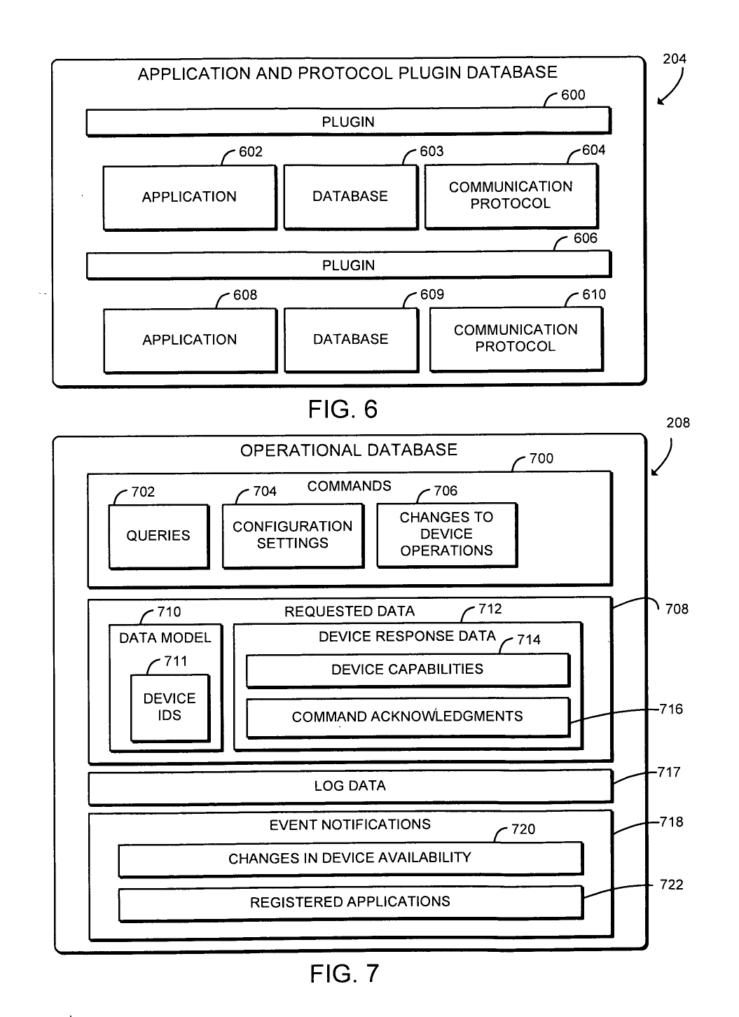

Referring now to FIG. 3, in use, the gateway computing device 102 may execute a method 300 for managing plugins that add functionality to the gateway computing device 102. The method 300 begins in block 302, in which the gateway computing device 102 determines whether to install a plugin. In the illustrative embodiment, the gateway computing device 102 may receive a request to install a plugin. For example, the request may be transmitted from a remote computing device, such as the client computing device 104 or the server computing device 126. After the gateway computing device 102 determines to install a plugin, the method 300 advances to block 304. As indicated in block 304, the gateway computing device 102 installs a plugin (e.g., a plugin 600 shown in FIG. 6). In the illustrative embodiment, in block 306, the gateway computing device 102 may install the plugin 600 at run time. Further, in block 308, the gateway computing device 102 may install the plugin 600 without stopping or restarting unrelated operations, such as ongoing communications with remote devices, or restarting the gateway computing device 102. Accordingly, existing communications between the gateway computing device 102 and other devices (e.g., field devices 105, client computing device 104, and/or server computing device 126) may continue uninterrupted as the plugin 600 is installed. As shown in block 310, the gateway computing device 102 may receive the plugin 600 from a remote computing device (e.g., the client computing device 104 or the server computing device 126) in some embodiments. Additionally, in some embodiment in block 312, the gateway computing device 102 may install a plugin 600 be associated with (i.e., enable communication associated with) a particular communication protocol, an application, and/or a database. The communication protocol may be, for example, an MQ telemetry transport (“MQTT”) protocol. The application may be an application configured to execute on a remote computing device or an application configured to execute on the gateway computing device 102.

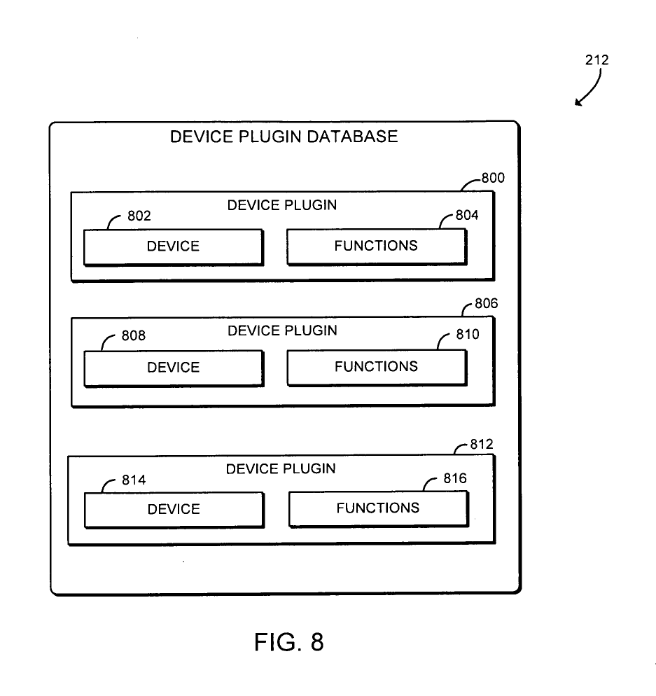

In some embodiments, in block 314, installing the plugin 600 enables the gateway computing device 102 to log data to a remote computing device, such as the server computing device 126. Additionally or alternatively, as indicated in block 316, installing the plugin 600 may enable the gateway computing device 102 to communicate with a field device 105, such as a sensor device 106. Accordingly, in such embodiments, the plugin 600 may be embodied as a device plugin (e.g., a device plugin 800 shown in FIG. 8). Additionally, as indicated by block 318, installing the plugin 600 may enable the gateway computing device 102 to transmit a query (e.g., a query 702) to one or more field devices 105 to determine capabilities 714 of the one or more field devices 105. Further, as indicated by block 320, installing the plugin 600 may enable the gateway computing device 102 to transmit configuration settings 704 to a field device 105, such as a sensor device 106.

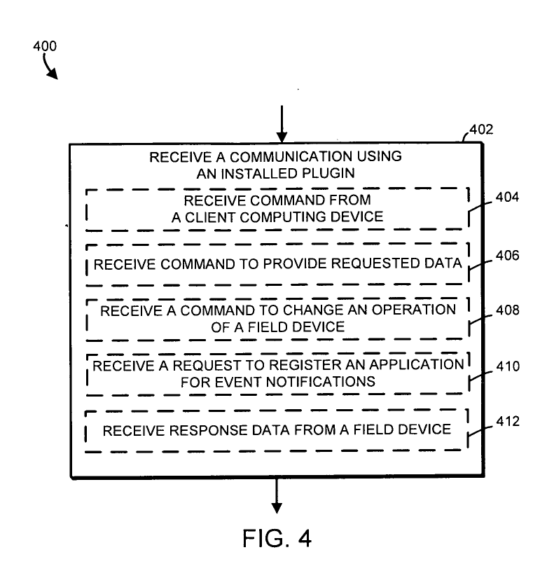

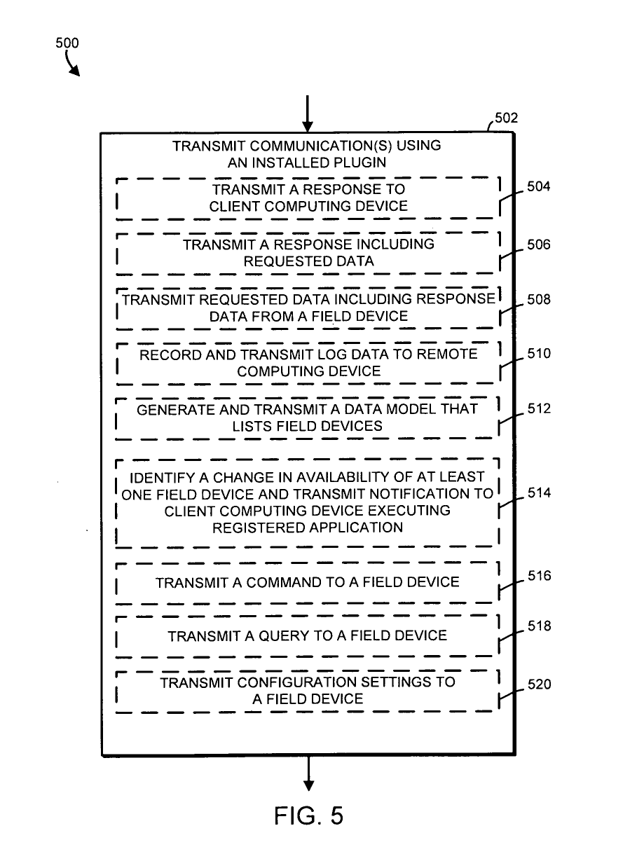

After the gateway computing device 102 has installed the plugin 600, the gateway device utilizes the plugin 600, as shown at block 322. In the illustrative embodiment, the gateway computing device 102 is configured to receive communications using the installed plugin 600, as shown in block 324 and described in more detail below in regard to method 400 of FIG. 4. Additionally, in the illustrative embodiment in block 326, the gateway computing device 102 is configured to transmit communications using the plugin 600 as described in more detail below in regard to method 500 of FIG. 5. It should be understood that operations in block 322 may occur concurrently with installations and/or deletions of plugins from gateway computing device 102.

Subsequently, in block 328, the gateway computing device 102 determines whether to delete a plugin (e.g., the plugin 600). For example, the gateway computing device 102 may receive a request from a remote computing device to delete a plugin (e.g., the plugin 600). If so, in block 330, the gateway computing device 102 deletes the plugin 600. In the illustrative embodiment, for example, the gateway computing device 102 may delete the plugin 600 without stopping or restarting operations that are unrelated to the plugin, such as ongoing communications between the gateway computing device 102 and other devices through the use of other plugins. After the plugin has been deleted in block 330 or if the plugin is not to be deleted in block 328, the method 300 loops back to block 302 in which the gateway computing device 102 determines whether to install another plugin. Although shown in sequence, it should be understood that the installation, utilization, and deletion of plugins may occur concurrently (e.g., in parallel).

Referring now to FIG. 4, in use, the gateway computing device 102 may execute a method 400 for receiving communications using an installed plugin (e.g., plugin 600). The method 400 may be performed as, for example, part of block 324 of method 300 of FIG. 3. The method 400 begins with block 402 in which the gateway computing device 102 receives communication using an installed plugin. For example, in block 404, the gateway computing device 102 may receive a command (e.g., a command 700 as shown FIG. 7) from the client computing device 104. Additionally or alternatively, in some embodiments in block 406, the gateway computing device 102 may receive a command to provide requested data, such as data pertaining to a field device 105. Additionally or alternatively, in some embodiments in block 408, the gateway computing device 102 may receive a command to change an operation of a field device 105. For example, the command 700 request a change to a rate at which the temperature sensor device 112 measures an ambient temperature. As another example, the command 700 may request an actuator device 122 to change an orientation of a switch (not shown) or other device. Additionally or alternatively, in some embodiments in block 410, the gateway computing device 102 may receive a request to register an application for event notifications (e.g., an application configured to execute on a remote computing device). Additionally or alternatively, in some embodiments in block 412, the gateway computing device 102 may receive response data 712 (see FIG. 7) from the field device 105. It should be appreciated that the communications received by the gateway computing device 102 are transmitted using a communication protocol that the gateway computing device 102 was unable to communicate with, until the gateway computing device 102 installed the corresponding plugin (e.g., plugin 600).

Referring now to FIG. 5, in use, the gateway computing device 102 may execute a method 500 for transmitting communications using an installed plugin (e.g., plugin 600). The method 500 may be performed as, for example, part of block 326 of method 300 of FIG. 3. The method 500 begins with block 502 in which the gateway computing device 102 transmits communications using an installed plugin. For example, in block 504, the gateway computing device 102 may transmit a response to a remote computing device, such as the client computing device 104. Additionally or alternatively, in block 506, the gateway computing device 102 may transmit a response that includes requested data 708. For example, in block 508, the gateway computing device 102 may transmit a response that includes requested data 708 including response data 712 (see FIG. 7) from a field device 105 generated in response to a command 700 such as a query 702 (see FIG. 7). Additionally or alternatively, in block 510, the gateway computing device 102 may transmit record and transmit log data 717 to a remote computing device, for example to server computing device 126. Additionally or alternatively, in block 512, the gateway computing device 102 may generate a data model 710 (see FIG. 7) that lists field devices 105 that are connected to the gateway computing device 102. For example, in some embodiments, the gateway computing device 102 is configured to generate a data model 710 that lists the field devices 105 by device identifiers (IDs) 711 (see FIG. 7) assigned to each field device 105. In other embodiments, the data model 710 lists the field device 105 by other indicia, and not necessarily by device identifiers 711. Further, in some embodiments, the data model 710 includes additional information about the field devices 105. As further indicated in block 510, the gateway computing device 102 may transmit the data model 710, for example to the client computing device 104.

Additionally or alternatively, in block 514, the gateway computing device 102 may identify a change in availability of at least one field device 105. For example, the gateway computing device 102 may determine that the temperature sensor device 112 was previously offline and has now come online. Additionally, as indicated at block 512, the gateway computing device 102 may transmit a notification to a computing device, for example the client computing device 104, executing an application registered to receive such notifications (e.g., a first application 602). The notification may indicate the change in availability of the field device 105 (e.g., temperature sensor device 112).

In some embodiments, in block 516, the gateway computing device 102 may transmit a command to a field device 105, such as a command to take a measurement or to operate an actuator. Additionally or alternatively, in block 518, the gateway computing device 102 may transmit a query 702 to a field device 105, for example to the temperature sensor device 112. In some embodiments, the query 702 may request data about capabilities of the field device 105. Additionally or alternatively, in block 520, the gateway computing device 102 may transmit configuration settings 704 (see FIG. 7) to a field device 105, for example the temperature sensor device 112. As an example, the gateway computing device 102 may transmit configuration settings that specify a resolution at which to measure a temperature or a temperature scale to use (e.g., Celsius, Kelvin, or Fahrenheit).

In the illustrative embodiment, the gateway computing device 102 provides one or more custom functions with respect to one or more field devices 105. More specifically, while the gateway computing device 102 generally provides a consistent and standardized set of functions to applications to interact with field devices 105, certain field devices 105 may be capable of performing certain operations that other field devices 105 are unable to perform. Accordingly, the gateway computing device 102 provides custom functions to invoke those operations. As an example, the first actuator device 122 may perform a single operation in response to an actuate command, while the second actuator device 124 performs an operation that requires additional, custom information, such as a degree or an amount of the operation to perform (e.g., rotate 90 degrees rather than rotate 360 degrees).

Referring now to FIG. 6, a simplified block diagram of example components of the application and protocol plugin database 204 is shown. The application and protocol plugin database 204 illustratively includes a plugin 600. The plugin 600 enables the gateway computing device 102 to communicate with an application 602 for example by providing a command set or interface that is specific to the application 602. As an example, the application 602 may communicate using a first set of Simple Object Access Protocol (SOAP) data objects. Accordingly, the plugin 600 is configured to parse and encode the SOAP data objects. In some embodiments, the application 602 executes on a remote computing device, for example the client computing device 104 and/or the server computing device 126. In some embodiments, the application 602 is executed, at least in part, by the gateway computing device 102. Additionally, the plugin 600 may enable the gateway computing device 102 to communicate with a database 603. More specifically, the plugin 600 may be configured to communicate with a MySQL database, using a command set associated therewith. Additionally, in some embodiments, the plugin 600 enables the gateway computing device 102 to communicate with remote computing devices, for example the client computing device 104 and/or the server computing device 126 using a particular communication protocol associated with the plugin 600, for example MQTT.

In some embodiments, the application and protocol plugin database 204 may also include additional plugins, such as a plugin 606. The plugin 606 enables the gateway computing device 102 to communicate with a another application 608, for example by providing a command set or interface that is specific to the application 608. As an example, the application 608 may be configured to transmit and receive a set of Representational State Transfer (REST) data objects. Accordingly, the plugin 606 is configured to parse and encode the REST data objects. In some embodiments, the application 608 executes on a remote computing device, for example the client computing device 104 and/or the server computing device 126. In some embodiments, the application 608 is executed, at least in part, by the gateway computing device 102. In some embodiments, the plugin 606 may also enable the gateway computing device 102 to communicate with a database 609. More specifically, the plugin 606 may be configured to communicate with a SQLite database, using a command set associated therewith. Additionally, the plugin 606 may enable the gateway computing device 102 to communicate with remote computing devices, for example the client computing device 104 and/or the server computing device 126 using a particular communication protocol, for example a Data Distribution Service (DDS) protocol. Although two plugins are shown in FIG. 6, it should be understood that the application and protocol plugin database 204 can include any number of plugins.

Referring now to FIG. 7, a simplified block diagram of example components of the operational database 208 is shown. The operational database 208 includes commands 700, for example commands received from the client computing device 104 and/or the server computing device 126. The commands 700 include queries 702, configuration settings 704, and changes to device operations 706. More specifically, the queries 702 include queries regarding the capabilities of one or more devices, such as the field devices 105 connected to the gateway computing device 102. In at least some embodiments, the queries 702 include queries regarding what devices (e.g., the field devices 105) are coupled to the gateway computing device 102. In some embodiments, the gateway computing device 102 receives the queries on a predefined periodic basis. For example, in some embodiments, the client computing device 104 transmits the queries 702 on a predefined time interval to receive information about the field devices 105 connected to the gateway computing device 102. The configuration settings 704 define at least one aspect of how one or more devices, for example one or more of the field devices 105 and/or the gateway computing device 102 is to operate. As an example, the configuration settings 704 may define a temperature scale for the temperature sensor device 112 to measure temperatures with, and/or a frequency at which to measure the temperature. As another example, the configuration settings 704 may define a frequency at which the gateway computing device 102 is to poll each field device 105 to determine whether each of the field devices 105 is operating. The changes to device operations 706 include, for example, instructions to perform one or more operations such as measuring a temperature or actuating a switch.

The operational database 208 also includes requested data 708. As described above, the gateway computing device 102 transmits the requested data 708 in response to at least some commands 700. In some implementations, the requested data includes a data model 710 that represents field devices 105 that are coupled to the gateway computing device 102. In some embodiments, the data model 710 is organized or sorted based on device IDs 711 associated with each field device 105. Further, in some embodiments, the requested data 708 includes device response data 712. The device response data 712 includes data transmitted from one or more field devices 105 in response to receiving a query 702 or other type of command 700 from the gateway computing device 102. In some embodiments, the device response data 712 includes device capabilities 714, such as a listing of operations that the device (e.g., field device 105) is capable of performing. Additionally, the response data 712 may include command acknowledgements 716, such as a confirmation from a field device 105 that the field device 105 received a command, a confirmation that the field device 105 performed the command, and/or a result of the performing the command, such as a temperature measurement.

The operational database 208 additionally includes log data 717 recorded by the gateway computing device 102. The log data 717 includes, as an example, records of data transmissions between the gateway computing device 102 and one or more other devices (e.g., field devices 105, client computing device 104, and/or server computing device 126). The log data 717 may also or alternatively include information about the internal operations of the gateway computing device 102, such as processor usage and/or memory usage, and/or any errors that occurred during operation. Further, the operational database 208 includes event notifications 718. As described above, the gateway computing device 102 may receive a request to register one or more applications to receive notifications when the availability (e.g., online or offline) of one or more field devices 105 changes. Accordingly, the event notifications 718 include changes in availability 720 of one or more of the field devices 105 and identifications of the applications 722 registered to receive the event notifications 720.

Referring now to FIG. 8, a simplified block diagram of components of the device plugin database 212 is shown. The device plugin database 212 includes a device plugin 800. The device plugin 800 enables the gateway computing device 102 to communicate with a field device 105, for example the temperature sensor device 112. More specifically, the plugin 800 is configured to transmit and receive data with the field device 105 according to a data format or protocol that the field device 105 uses. Additionally, the device plugin 800 includes a library of functions 804 that the field device 105 is capable of performing. The device plugin 800 is configured to invoke the functions 804 using function names and parameters that are specific to the field device 105. As described above, the device plugin module 210 abstracts or “hides” these details from the field device control and data agent module 206, enabling the field device control and data agent module 206 to invoke the functions in response to commands 700 received from applications (e.g., the application 600). Similarly, the device plugin database 212 includes a device plugin 806 that enables to gateway computing device 102 to communicate with another field device 105, such as the infrared sensor device 114. Additionally, the plugin 806 enables the gateway computing device 102 to invoke second functions 810 that the field device 105 is capable of performing. Likewise, the device plugin database 212 includes another device plugin 812 that enables the gateway computing device 102 to communicate with another field device 105, such as the actuator device 122. Additionally, the device plugin 812 enables the gateway computing device 102 to invoke functions 816 that the field device 105 is capable of performing. Although three device plugins are shown in FIG. 8, it should be understood that the device plugin database 212 can include any number of device plugins.

### EXAMPLES

Illustrative examples of the technologies disclosed herein are provided below. An embodiment of the technologies may include any one or more, and any combination of, the examples described below.

Example 1 includes a gateway device that supports plugins that enable functionality of the gateway device, the gateway device comprising an application and protocol plugin module to install, at run time, a first plugin associated with a first communication protocol and a first application, wherein the first plugin includes computer-executable instructions that enable the gateway device to use the first communication protocol to communicate with a client computing device that executes the first application; and a field device control and data agent module to use the first communication protocol to receive a command from the client computing device to provide requested data pertaining to at least one field device coupled to the gateway device and to use the first communication protocol to transmit the requested data to the client computing device, in response to the command.

Example 2 includes the subject matter of Example 1, and wherein the at least one field device includes a plurality of field devices, and the field device control and data agent module is further to generate a data model that includes a list of the plurality of field devices; and transmit the data model to the client computing device.

Example 3 includes the subject matter of any of Examples 1 and 2, and wherein the application and protocol plugin module is further to install, at run time, a second plugin that includes computer-executable instructions that enable the gateway device to use a second communication protocol that is different from the first communication protocol to communicate with a second application.

Example 4 includes the subject matter of any of Examples 1-3, and wherein the application and protocol plugin module is further to install, at run time, computer-executable instructions that enable the gateway device to communicate with a first database.

Example 5 includes the subject matter of any of Examples 1-4, and wherein the field device control and data agent module is further to receive the command after the first plugin is installed, without requiring the gateway device to restart after the first plugin is installed.

Example 6 includes the subject matter of any of Examples 1-5, and wherein the command is a first command, the application and protocol plugin module is further to receive a second command from a remote computing device to delete the first plugin from a memory of the gateway device; and delete the first plugin from the memory of the gateway device, in response to the second command.

Example 7 includes the subject matter of any of Examples 1-6, and wherein the application and protocol plugin module is further to receive the first plugin from a remote computing device.

Example 8 includes the subject matter of any of Examples 1-7, and wherein the field device control and data agent module is further to receive, from the client computing device, a request to register the first application to receive an event notification associated with an availability of the at least one field device; identify a change in the availability of the at least one field device, wherein the change in availability is one of the at least one field device being coupled to the gateway device and the at least one sensor being decoupled from the gateway device; and transmit the event notification to the client computing device that executes the first application in response to the identification of the change in the availability.

Example 9 includes the subject matter of any of Examples 1-8, and wherein the application and protocol plugin module is further to receive a second plugin that includes computer-executable instructions that enable the gateway device to communicate with the at least one field device.

Example 10 includes the subject matter of any of Examples 1-9, and further including a device plugin module to receive a second plugin that includes computer-executable instructions that enable the gateway device to communicate with the at least one field device.

Example 11 includes the subject matter of any of Examples 1-10, and wherein the command is to change an operation of the at least one field device, and the field device control and data agent module is further to transmit, at run time, the command to the at least one field device; receive response data from the at least one field device; and transmit the response data to the client computing device in the requested data.

Example 12 includes the subject matter of any of Examples 1-11, and wherein the second plugin includes computer-executable instructions that enable the gateway device to transmit a query to the at least one field device to determine one or more capabilities of the at least one field device, and the field device control and data agent module is further to transmit the query to the at least one field device.

Example 13 includes the subject matter of any of Examples 1-12, and wherein the second plugin includes computer-executable instructions that enable the gateway device to transmit configuration settings to the at least one field device, and the field device control and data agent module is further to transmit the configuration settings to the at least one field device.

Example 14 includes the subject matter of any of Examples 1-3, and wherein the at least one field device includes at least a first field device and a second field device, and the device plugin module is further to provide a first set of functions that are compatible with both the first field device and the second field device; and provide a second set of functions that are compatible with the second field device and incompatible with the first field device.

Example 15 includes the subject matter of any of Examples 1-14, and further including a device plugin module to receive a second plugin that includes computer-executable instructions that enable the gateway device to communicate with at least one of a magnetic sensor device, a temperature sensor device, an infrared sensor device, a vibration sensor device, a smart plug sensor device, and an illuminance sensor device.

Example 16 includes the subject matter of any of Examples 1-15, and further including a device plugin module to receive a second plugin that includes computer-executable instructions that enable the gateway device to communicate with at least one actuator device.

Example 17 includes a method for enabling functionality of a gateway device communicatively coupled to at least one field device using at least one plugin, the method comprising installing, by the gateway device at run time, a first plugin associated with a first communication protocol and a first application, the first plugin includes computer-executable instructions that enable the gateway device to use the first communication protocol to communicate with a client computing device that executes the first application; receiving, by the gateway device, a command from the client computing device using the first communication protocol to provide requested data pertaining to at least one field device coupled to the gateway device; and transmitting, by the gateway device, the requested data to the client computing device using the first communication protocol, in response to the command.

Example 18 includes the subject matter of Example 17, and wherein the at least one field device includes a plurality of field devices, the method further comprising generating, by the gateway device, a data model that includes a list of the plurality of field devices; and transmitting, by the gateway device, the data model to the client computing device.

Example 19 includes the subject matter of any of Examples 17 and 18, and further including installing, by the gateway device at run time, a second plugin that includes computer-executable instructions that enable the gateway device to communicate with a second application using a second communication protocol that is different from the first communication protocol.

Example 20 includes the subject matter of any of Examples 17-19, and further including installing, by the gateway device at run time, a second plugin that includes computer-executable instructions that enable the gateway device to communicate with a first database.

Example 21 includes the subject matter of any of Examples 17-20, and wherein receiving the command from the client computing device using the first communication protocol further comprises receiving the command after installing the first plugin, without restarting the gateway device.

Example 22 includes the subject matter of any of Examples 17-21, and wherein the command is a first command, the method further comprising receiving a second command from a remote computing device to delete the first plugin from a memory of the gateway device; and deleting the first plugin from the memory of the gateway device, in response to the second command.

Example 23 includes the subject matter of any of Examples 17-22, and further including receiving the first plugin from a remote computing device.

Example 24 includes the subject matter of any of Examples 17-23, and further including receiving, from the client computing device, a request to register the first application to receive an event notification associated with an availability of the at least one field device; identifying a change in the availability of the at least one field device, wherein the change in availability is one of the at least one field device being coupled to the gateway device and the at least one sensor being decoupled from the gateway device; and transmitting the event notification to the client computing device that executes the first application in response to identifying the change in the availability.

Example 25 includes the subject matter of any of Examples 17-24, and further including receiving a second plugin that includes computer-executable instructions that enable the gateway device to transmit log data to a remote computing device; and transmitting the log data to the remote computing device.

Example 26 includes the subject matter of any of Examples 17-25, and further including receiving, by the gateway device at run time, a second plugin that includes computer-executable instructions that enable the gateway device to communicate with the at least one field device.

Example 27 includes the subject matter of any of Examples 17-26, and wherein receiving the command further comprises receiving a command to change an operation of the at least one field device, the method further comprising transmitting, by the gateway device at run time, the command to the at least one field device; receiving response data from the at least one field device; and transmitting the response data to the client computing device in the requested data.

Example 28 includes the subject matter of any of Examples 17-27, and wherein the second plugin includes computer-executable instructions that enable the gateway device to transmit a query to the at least one field device to determine one or more capabilities of the at least one field device, the method further comprising transmitting the query to the at least one field device.

Example 29 includes the subject matter of any of Examples 17-28, and wherein the second plugin includes computer-executable instructions that enable the gateway device to transmit configuration settings to the at least one field device, the method further comprising transmitting the configuration settings to the at least one field device.

Example 30 includes the subject matter of any of Examples 17-29, and wherein the at least one field device includes at least a first field device and a second field device, the method further comprising providing, by the gateway device, a first set of functions that are compatible with both the first field device and the second field device; and providing, by the gateway device, a second set of functions that are compatible with the second field device and incompatible with the first field device.

Example 31 includes the subject matter of any of Examples 17-30, and further including receiving, by the gateway device at run time, a second plugin that includes computer-executable instructions that enable the gateway device to communicate with at least one of a magnetic sensor device, a temperature sensor device, an infrared sensor device, a vibration sensor device, a smart plug sensor device, and an illuminance sensor device.

Example 32 includes the subject matter of any of Examples 17-31, and further including receiving, by the gateway device at run time, a second plugin that includes computer-executable instructions that enable the gateway device to communicate with at least one actuator device.

Example 33 includes one or more computer-readable storage media comprising a plurality of instructions stored thereon that, when executed, cause a gateway device communicatively coupled to at least one field device to perform the method of any of Examples 17-32.

Example 34 includes a gateway device that supports plugins that enable functionality of the gateway device, the gateway device comprising means for installing a first plugin associated with a first communication protocol and a first application, the first plugin includes computer-executable instructions that enable the gateway device to use the first communication protocol to communicate with a client computing device that executes the first application; means for receiving a command from the client computing device using the first communication protocol to provide requested data pertaining to at least one field device coupled to the gateway device; and means for transmitting, by the gateway device, the requested data to the client computing device using the first communication protocol, in response to the command.

Example 35 includes the subject matter of Example 34, and wherein the at least one field device includes a plurality of field devices, the gateway device further comprising means for generating a data model that includes a list of the plurality of field devices; and means for transmitting the data model to the client computing device.

Example 36 includes the subject matter of any of Examples 34 and 35, and further including means for installing a second plugin that includes computer-executable instructions that enable the gateway device to communicate with a second application using a second communication protocol that is different from the first communication protocol.

Example 37 includes the subject matter of any of Examples 34-36, and further including means for installing a second plugin that includes computer-executable instructions that enable the gateway device to communicate with a first database.

Example 38 includes the subject matter of any of Examples 34-37, and wherein the means for receiving the command from the client computing device using the first communication protocol comprises means for receiving the command after installing the first plugin, without restarting the gateway device.

Example 39 includes the subject matter of any of Examples 34-38, and wherein the command is a first command, the gateway device further comprising means for receiving a second command from a remote computing device to delete the first plugin from a memory of the gateway device; and means for deleting the first plugin from the memory of the gateway device, in response to the second command.

Example 40 includes the subject matter of any of Examples 34-39, and further including means for receiving the first plugin from a remote computing device.

Example 41 includes the subject matter of any of Examples 34-40, and further including means for receiving a request to register the first application to receive an event notification associated with an availability of the at least one field device; means for identifying a change in the availability of the at least one field device, wherein the change in availability is one of the at least one field device being coupled to the gateway device and the at least one sensor being decoupled from the gateway device; and means for transmitting the event notification to the client computing device that executes the first application in response to identifying the change in the availability.

Example 42 includes the subject matter of any of Examples 34-41, and further including means for receiving a second plugin that includes computer-executable instructions that enable the gateway device to transmit log data to a remote computing device; and means for transmitting the log data to the remote computing device.

Example 43 includes the subject matter of any of Examples 34-42, and further including means for receiving, at run time, a second plugin that includes computer-executable instructions that enable the gateway device to communicate with the at least one field device.

Example 44 includes the subject matter of any of Examples 34-43, and wherein the means for receiving the command further comprises means for receiving a command to change an operation of the at least one field device, the gateway device further comprising means for transmitting, at run time, the command to the at least one field device; means for receiving response data from the at least one field device; and means for transmitting the response data to the client computing device in the requested data.

Example 45 includes the subject matter of any of Examples 34-44, and wherein the second plugin includes computer-executable instructions that enable the gateway device to transmit a query to the at least one field device to determine one or more capabilities of the at least one field device, the gateway device further comprising means for transmitting the query to the at least one field device.

Example 46 includes the subject matter of any of Examples 34-45, and wherein the second plugin includes computer-executable instructions that enable the gateway device to transmit configuration settings to the at least one field device, the gateway device further comprising means for transmitting the configuration settings to the at least one field device.

Example 47 includes the subject matter of any of Examples 34-46, and wherein the at least one field device includes at least a first field device and a second field device, the gateway device further comprising means for providing a first set of functions that are compatible with both the first field device and the second field device; and means for providing a second set of functions that are compatible with the second field device and incompatible with the first field device.

Example 48 includes the subject matter of any of Examples 34-47, and further including means for receiving, at run time, a second plugin that includes computer-executable instructions that enable the gateway device to communicate with at least one of a magnetic sensor device, a temperature sensor device, an infrared sensor device, a vibration sensor device, a smart plug sensor device, and an illuminance sensor device.

Example 49 includes the subject matter of any of Examples 34-48, and further including means for receiving a second plugin that includes computer-executable instructions that enable the gateway device to communicate with at least one actuator device.

1. A gateway device that supports plugins that enable functionality of the gateway device, the gateway device comprising:
an application and protocol plugin module to install, at run time, a first plugin associated with a first communication protocol and a first application, wherein the first plugin includes computer-executable instructions that enable the gateway device to use the first communication protocol to communicate with a client computing device that executes the first application; and
a field device control and data agent module to use the first communication protocol to receive a command from the client computing device to provide requested data pertaining to at least one field device coupled to the gateway device and to use the first communication protocol to transmit the requested data to the client computing device, in response to the command.

2. The gateway device of claim 1, wherein the at least one field device includes a plurality of field devices, and the field device control and data agent module is further to:
generate a data model that includes a list of the plurality of field devices; and
transmit the data model to the client computing device.

3. The gateway device of claim 1, wherein the application and protocol plugin module is further to install, at run time, a second plugin that includes computer-executable instructions that enable the gateway device to use a second communication protocol that is different from the first communication protocol to communicate with a second application.

4. The gateway device of claim 1, wherein the application and protocol plugin module is further to install, at run time, computer-executable instructions that enable the gateway device to communicate with a first database.

5. The gateway device of claim 1, wherein the field device control and data agent module is further to receive the command after the first plugin is installed, without requiring the gateway device to restart after the first plugin is installed.

6. The gateway device of claim 1, wherein the command is a first command, the application and protocol plugin module is further to:
receive a second command from a remote computing device to delete the first plugin from a memory of the gateway device; and
delete the first plugin from the memory of the gateway device, in response to the second command.

7. The gateway device of claim 1, wherein the application and protocol plugin module is further to receive the first plugin from a remote computing device.

8. The gateway device of claim 1, wherein the field device control and data agent module is further to:
receive, from the client computing device, a request to register the first application to receive an event notification associated with an availability of the at least one field device;
identify a change in the availability of the at least one field device, wherein the change in availability is one of the at least one field device being coupled to the gateway device and the at least one sensor being decoupled from the gateway device; and
transmit the event notification to the client computing device that executes the first application in response to the identification of the change in the availability.

9. The gateway device of claim 1, wherein the application and protocol plugin module is further to receive a second plugin that includes computer-executable instructions that enable the gateway device to communicate with the at least one field device.

10. One or more computer-readable storage media comprising a plurality of instructions stored thereon that, when executed, cause a gateway device to:
install, at run time, a first plugin associated with a first communication protocol and a first application, the first plugin includes computer-executable instructions that enable the gateway device to use the first communication protocol to communicate with a client computing device that executes the first application;
receive a command from the client computing device with the first communication protocol to provide requested data pertaining to at least one field device coupled to the gateway device; and
transmit the requested data to the client computing device with the first communication protocol, in response to the command.

11. The one or more computer-readable storage media of claim 10, wherein the at least one field device includes a plurality of field devices and the plurality of instructions, when executed, further cause the gateway device to:
generate a data model that includes a list of the plurality of field devices; and
transmit the data model to the client computing device.

12. The one or more computer-readable storage media of claim 10, wherein the plurality of instructions, when executed, further cause the gateway device to install, at run time, a second plugin that includes computer-executable instructions that enable the gateway device to communicate with a second application with a second communication protocol that is different from the first communication protocol.

13. The one or more computer-readable storage media of claim 10, wherein the plurality of instructions, when executed, further cause the gateway device to install, at run time, a second plugin that includes computer-executable instructions that enable the gateway device to communicate with a first database.

14. The one or more computer-readable storage media of claim 10, wherein to receive the command from the client computing device with the first communication protocol comprises to receive the command after the first plugin is installed, without a restart of the gateway device.

15. The one or more computer-readable storage media of claim 10, wherein the command is a first command and the plurality of instructions, when executed, further cause the gateway device to:
receive a second command from a remote computing device to delete the first plugin from a memory of the gateway device; and
delete the first plugin from the memory of the gateway device, in response to the second command.

16. The one or more computer-readable storage media of claim 10, wherein the plurality of instructions, when executed, further cause the gateway device to receive the first plugin from a remote computing device.

17. The one or more computer-readable storage media of claim 10, wherein the plurality of instructions, when executed, further cause the gateway device to:
receive from the client computing device, a request to register the first application to receive an event notification associated with an availability of the at least one field device;
identify a change in the availability of the at least one field device, wherein the change in availability is one of the at least one field device being coupled to the gateway device and the at least one sensor being decoupled from the gateway device; and
transmit the event notification to the client computing device that executes the first application in response to identifying the change in the availability.

18. A method for enabling functionality of a gateway device communicatively coupled to at least one field device using at least one plugin, the method comprising:
installing, by the gateway device at run time, a first plugin associated with a first communication protocol and a first application, the first plugin includes computer-executable instructions that enable the gateway device to use the first communication protocol to communicate with a client computing device that executes the first application;
receiving, by the gateway device, a command from the client computing device using the first communication protocol to provide requested data pertaining to at least one field device coupled to the gateway device; and
transmitting, by the gateway device, the requested data to the client computing device using the first communication protocol, in response to the command.

19. The method of claim 18, wherein the at least one field device includes a plurality of field devices, the method further comprising:
generating, by the gateway device, a data model that includes a list of the plurality of field devices; and
transmitting, by the gateway device, the data model to the client computing device.

20. The method of claim 18, further comprising installing, by the gateway device at run time, a second plugin that includes computer-executable instructions that enable the gateway device to communicate with a second application using a second communication protocol that is different from the first communication protocol.

21. The method of claim 18, further comprising installing, by the gateway device at run time, a second plugin that includes computer-executable instructions that enable the gateway device to communicate with a first database.

22. The method of claim 18, wherein receiving the command from the client computing device using the first communication protocol further comprises receiving the command after installing the first plugin, without restarting the gateway device.

23. The method of claim 18, wherein the command is a first command, the method further comprising:
receiving, by the gateway device, a second command from a remote computing device to delete the first plugin from a memory of the gateway device; and
deleting, by the gateway device, the first plugin from the memory of the gateway device, in response to the second command.

24. The method of claim 18, further comprising receiving, by the gateway device, the first plugin from a remote computing device.

25. The method of claim 18, further comprising:
receiving, by the gateway device, from the client computing device, a request to register the first application to receive an event notification associated with an availability of the at least one field device;
identifying, by the gateway device, a change in the availability of the at least one field device, wherein the change in availability is one of the at least one field device being coupled to the gateway device and the at least one sensor being decoupled from the gateway device; and
transmitting, by the gateway device, the event notification to the client computing device that executes the first application in response to identifying the change in the availability.
